(19) United States
(12) Patent Application Publication
(10) Pub. No.: US 2009/0166291 A1
(43) Pub. Date: Jul. 2, 2009

(54) FILTRATION OF AN AQUEOUS PROCESS STREAM IN POLYMER BASED PARTICLE PRODUCTION

(76) Inventor: Paul H. JACKSON, Loveland, OH (US)

Correspondence Address: HASSE & NESBITT LLC, 8837 CHAPEL SQUARE DRIVE, SUITE C, CINCINNATI, OH, 45249, US

(21) Appl. No.: 12/256,102

(22) Filed: Oct. 22, 2008

Related U.S. Application Data
(60) Provisional application No. 61/006,165, filed on Dec. 26, 2007.

(51) Int. Cl. B01D 61/58

(52) U.S. Cl. 210/641

(57) ABSTRACT

Process for treating an aqueous particle dispersion containing water-insoluble polymer particles and a water-soluble dispersant, the concentration of dispersant in water being less than that of the polymer particles. The process comprises subjecting the aqueous particle dispersion to solid particle filtration and then subjecting the resulting substantially particle-free aqueous solution to membrane filtration to obtain a permeate stream of substantially purified water and a retentate stream having an increased dispersant concentration. The permeate stream can be reused and/or recycled as wash water during the solid particle filtration. The retentate stream can be recycled as aqueous dispersant for size reducing the water-insoluble polymer particles at a temperature at or above the softening point of the polymer.

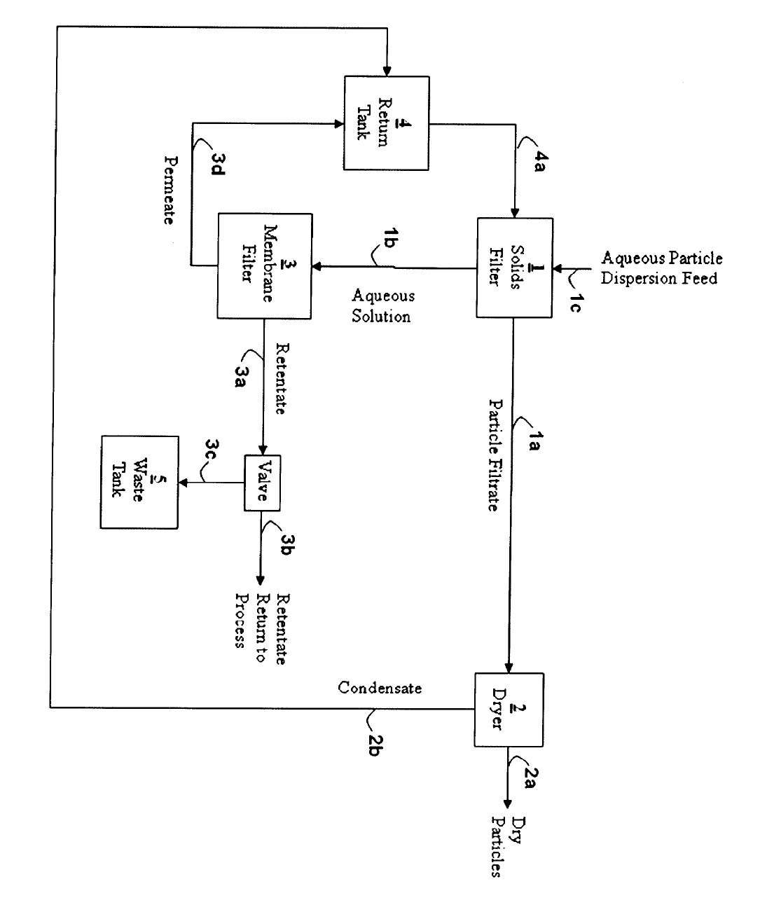

### CROSS REFERENCE TO RELATED APPLICATION

This Application claims the benefit of U.S. Provisional Application No. 61/006,165, filed Dec. 26, 2007.

### FIELD OF THE INVENTION

The invention relates to a process for preparing an aqueous dispersion containing water-insoluble polymer particles and water-soluble dispersant, the fraction of such dispersants being smaller than that of said polymer particles, which comprises subjecting the dispersion to solid particle filtration and then subjecting the substantially particle-free aqueous dispersant solution to membrane filtration to obtain a permeate stream of substantially purified water and a retentate stream having an increased concentration of dispersant that is suitable for reuse in particle production. For the purpose of describing this invention, the term ‘dispersants’ generally relates to a compound or combination of compounds that facilitate the formation, dispersion and/or stabilization of polymer particles in water, such as but not limited to surfactants, emulsifying aids or colloidal agents.

### BACKGROUND OF THE INVENTION

To those trained in the art, there are several basic methods for producing polymeric particles and particle dispersions: mechanical grinding, solvent dissolution and precipitation, emulsion polymerization, and aqueous dispersion.

Mechanical grinding or comminution can be single or multiple stages of various techniques for cleaving, shattering and abrading polymers. During the milling of a material, a stress must be induced which exceeds the fracture strength of the material. The mode of failure and the path that it follows depends largely on the material, the shape and the structure of the particle, and on the way and rate at which load is applied. The way the load is applied will control the stresses that induce fracture extension or growth inside the particle. The force used to induce this growth can be one of compression, which causes the particle to fracture in tension. Or, the applied load may be in shear, like when two particles impact or rub against each other causing a direct tensile force on the particles. Generally, the use of load forces well above the fracture toughness of the material are used to achieve optimum shattering, crack growth and hopefully crack bifurcation.

Most polymers can be size reduced using comminution. However, the physical properties and chemical characteristics of the polymer blend or composite will determine the energy requirements, and how that energy needs to be applied for sufficient size reduction. For example, polyolefin waxes are much more easily size reduced than olefin polymers with high molecular weights because of the inferior fracture toughness of waxes.

U.S. Pat. No. 6,824,086 issued to Mazurkiewicz et al exemplifies how various comminution techniques can be combined into a process. Mazurkiewicz teaches how to combine high pressure fluid jet, cavitation, and controlled collision into an integrated process. Each comminution technique has distinct advantages, however it is generally known that the higher the fracture toughness of the polymer, blend or composite, the greater the energy requirements, and hence cost, to size reduce.

Another method for size reducing polymers is to dissolve the polymer in a solvent, typically a volatile organic solvent, and then precipitate the polymer out of solution based on the solubility characteristics of the polymer. Water or aqueous liquids are commonly used as anti-solvents for forcing particle precipitation. Solvent-based precipitation methods are typically suited for the production of dry, finely divided powders based on the ability to flash off the solvent. Various approaches for this method are well known in the art.

One of the first teachings of solvent precipitation methods was U.S. Pat. No. 2,202,481 issued to Cox et al. In this approach, Cox demonstrated that vinyl resins can be precipitated from dissolution in alcohol or volatile organic solvent such as toluene using water as the anti-solvent. U.S. Pat. No. 2,313,144 is arguably the first teaching for the approach of solvent/anti-solvent properties of olefin polymers with molecular weight up to 40,000 Daltons. In this method, water is likewise used as an anti-solvent to facilitate solvent removal leaving a finely divided polymer powder. U.S. Pat. No. 2,870,113 issued to Jones teaches another method of dissolving olefin polymers in a volatile organic solvent such as benzene. In this method, the polymer swollen with solvent is recovered from free solvent The swollen polymer is then comminuted with a dispersing agent, such as water, to reduce sizes to below 18 microns.

U.S. Pat. No. 2,947,715 issued to Charlet et al is a similar method of dissolving olefin polymers and butylene polymers in a volatile organic solvent such as hexane and using water as the anti-solvent while emulsifying with heat and shear. The target of this patent was to create a thick, creamy aqueous stream of finely divided polymer particles. This patent also teaches the use of specific emulsifiers consisting of a mixture of non-ionic and anionic emulsifying aids. U.S. Pat. No. 3,008,946 issued to Rhodes et al teaches methods for dissolving olefin polymers in solvent using anti-solvents to precipitate the finely divided polymer particles. Rhodes specifically teaches using heated perchloroethylene as the solvent and a solution of isopropyl alcohol and water as the anti-solvent. U.S. Pat. No. 3,154,530 issued to Mullen also teaches how to micronize ethylene polymers by dissolving in organic solvents, heated to above the polymers solution temperature of chosen solvent and then slowly cooled in the absence of turbulence to precipitate the polymer powders. In this invention, it is optional to use anti-solvents such as water. U.S. Pat. No. 3,244,687 issued to Spindler teaches a method for dissolving polyethylene of substantial molecular weight in a suitable aromatic or halogenated hydrocarbon solvent of boiling point ranging from 10° C. to 80° C. The mixture is heated to above the dissolution temperature of the polymer, vigorously agitated and then precipitated using an anti-solvent with boiling points ranging from 120° C.-150° C. Examples of anti-solvents were alcohols, ethers, ketones, aldehydes and ether-alcohols. The polymer solution is maintained at above supersaturation conditions where only a fraction of the polymer is precipitated. Coathylene S. A. of Fribourg, Switzerland was also assigned U.S. Pat. No. 3,558,576, a similar teaching for solvent precipitation for size reducing styrene-butadiene polymers and U.S. Pat. No. 3,679,638 for precipitating copolyamides.

U.S. Pat. No. 3,971,749 issued to Blunt discusses common problems and solutions for size reducing polypropylene polymers using solvent precipitation. U.S. Pat. No. 4,510,305 assigned to Coathylene S. A. also describes the problem and solutions for solvent precipitation for size reducing polypropylene resins. Technologies are known for size reducing polymers of substantial molcular weights using solvents.

Another approach for producing polymer particles is to synthesize the polymer in an aqueous emulsion, commonly termed ‘emulsion polymerization’ or ‘suspension polymerization’, or to synthesize in a commercial-scale polymer reactor using a catalyst of reduced size to enable to the formation of polymer particles from monomer.

Emulsion polymerization is a type of radical polymerization that usually starts with an emulsion incorporating water, monomer, and dispersant. The most common type of emulsion polymerization is an oil-in-water emulsion, in which droplets of monomer (the oil) are emulsified (with dispersants) in a continuous phase of water. Water-soluble polymers, such as certain polyvinyl alcohols or hydroxyethyl celluloses, can also be used to act as emulsifiers/stabilizers.

Emulsion polymerization is used to manufacture several commercially important polymers. Many of these polymers are used as solid materials and must be isolated from the aqueous dispersion after polymerization. In other cases the dispersion itself is the end product. A dispersion resulting from emulsion polymerization is often called a latex or an emulsion (even though “emulsion” strictly speaking refers to a dispersion of a liquid in water). These emulsions find applications in adhesives, paints, paper coating and textile coatings. They are finding increasing acceptance and are preferred over solvent-based products in these applications as a result of their eco-friendliness.

Emulsion polymerization process can be used for synthetic rubbers such as styrene-butadiene, nitrile, or neoprene as well as semi-crystalline polymers such as polyvinylacetate, polyvinylchloride, polymethylmethacrylate, acrilonitrile butadiene styrene, polytetraflouroethylene and polystyrene.

An alternative method for polymerizing polymer particles is in large reactor synthesis using a catalyst. In this approach, polymerization occurs on a micro or nano-scale catalyst support whereby the resultant polymer particles produced are of a small particle size. Such reactors can be slurry, solution or gas phase systems using either solid or liquid catalysts. Examples of such techniques can be found in U.S. Pat. No. 4,972,035 issued to Suga et al, U.S. Pat. No. 4,831,061 issued to Hilaire, and U.S. Pat. No. 6,716,924 issued to Tsutsui et al.

Another approach for producing particles is by aqueous polymer dispersion. The process for manufacture of the aqueous polymer particle dispersion can be generally described by the following steps; 1) softening or melting where the water-insoluble polymer is delivered at or above it's softening point to a chamber where it is introduced to an aqueous dispersant solution, 2) wetting of the polymer surface where all of the gases and moisture are displaced from the surface and between the molten plastic agglomerates and replaced by a dispersant solution, 3) mixing or introduction of mechanical energy (impact and shear forces) where the plastic agglomerates are broken up and disrupted into smaller units and uniformly distributed throughout the dispersant solution and 4) stabilization of the solid/liquid suspension where small plastic particles are stabilized by the dispersants(s) and/or colloidal agent (s) in order to prevent the formation of uncontrolled re-agglomeration.

Methods to produce stable aqueous particle dispersions and emulsions are known. The first teaching of aqueous dispersions of polymers was U.S. Pat. No. 2,595,797 issued to Leyonmark et al which taught using volatile organic emulsifying aids such as methyl chloride and dioctyl ester of sodium sulfo-succinic acid in water to size reduce with subsequent flashing of the solvent from the water stream. U.S. Pat. No. 3,055,853 issued to Pickell describes using the principles of oil-in-water emulsions for producing resin-in-water emulsions. Pickell describes a continuous process for size reducing polymers using water and an emulsifying aid such as a volatile organic solvent.

U.S. Pat. No. 3,308,211 issued to Plastridge is the first teaching of combining molten thermoplastic resins with a water-based dispersant system where the dispersing stage is maintained at temperatures well above the melting and softening temperatures of the polymer. Similar to U.S. Pat. No. 2,313,144 and U.S. Pat. No. 2,538,466, the invention of U.S. Pat. No. 3,308,211 requires first dissolving the polymer in a volatile organic solvent that is then sheared in an aqueous system followed by temperature reduction and particle recovery. The first patent to teach the additional use of a surfactant in water was U.S. Pat. No. 3,322,720 issued to Dempsey et al. According to Dempsey, Igepal 630 can be dissolved in water and operated as the mixing medium at elevated temperatures for size reducing polypropylene reactor powder. In this invention, the residual solvent from polypropylene synthesis is used as an emulsifying aid.

U.S. Pat. No. 3,347,811 issued to Bissot teaches a method for size reducing acid copolymers, such as ethylene acrylic acid resins with melt indices ranging from 3 to 150 g/10-min. The invention by Bissot is similarly dependent on dissolving the polymer in preferred toluene followed by emulsification with water in an emulsifying mill. In this invention sodium dodecyl sulfate is added to the water and once particles are formed in the mill, the volatile organic solvents are evaporated.

U.S. Pat. Nos. 3,418,265, 3,422,049, 3,432,483, 3,449,291, 3,472,801, 3,522,036, 3,586,654, 3,746,681 and 4,148,766 assigned to National Distillers and Chemical Corp. teach methods for size reducing polymers in water-based dispersion systems where the dispersion zone is operated above the melting point of the polymer. This body of prior art teaches using water-based dispersion systems without the previously necessary incorporation of volatile organic solvents or acid functionalized polymers as emulsifying aids. These patents teach the use of high molecular weight non-ionic surfactants of di-block and tri-block copolymers of ethylene oxide (EO) and propylene oxide (PO). This body of prior art teaches a preferred method for size reducing polymers using only water and surfactant as the dispersing media, in a continuous process or batch process, as well as the incorporation of an optional emulsifying aid such as volatile organic solvents.

The prior art for producing particles by polymerizing in aqueous liquids or size reducing already synthesized polymers in aqueous systems does not teach how to effectively recover the dispersant liquids after dry particle recovery for reuse in the process. This invention teaches the novel use of membrane filtration to overcome this critical issue that can be used by any aqueous-based micronization or polymerization process that desires to recover particles as dry powders, and reuse the dispersant in a continuous process.

Today, the use of solvents, especially hydrocarbon solvents, for industrial uses is counter to the global trends of eliminating hazardous solvents and developing new technologies that do not burden the environment. Even though solvent-based methods are very conducive to size reducing polymers of substantial molecular weights, they are burdened by difficulties and hazards associated with handling hydrocarbon fluids. Elimination of hydrocarbon-based solvents is being championed by global companies of all sizes in favor of safer and cleaner technologies with reduced environmental profiles.

Aqueous particle dispersions are preferred but there is a weakness in the process. The new invention addresses this weakness by providing for recovering and reconstituting and recycling aqueous solutions after separation of solid plastic particles in a continuous process.

In general, the design of a continuous system for size reducing polymers in preferred aqueous liquid medium poses a problem by creating large volumes of aqueous dispersant waste after solids filtration and water washing. Waste water handling and aqueous dispersant recycling are critical issues for manufacturing preferred dry, finely-divided polymer powders. There is a need in the production of polymer particles for new technology that can reduce this waste burden, offer improved efficiencies, and result in a more environmentally-friendly option for the production of dry finely divided powders. However to recover the formed polymer particles as dry, finely divided powders, there is need for liquid/solid separation that necessitates a further need for handling the filtration permeate. It is desirable to recycle the aqueous dispersant for reducing cost, eliminating waste, and reducing the impact on the environment as well as meeting stringent state, local and Federal regulatory requirements for waste management.

U.S. Pat. No. 3,432,483 details a continuous process for producing particles in water and surfactant media as well as the recovery of the polymer particles, however does not teach methods for reusing or recycling the aqueous dispersant for reduced waste, significant improvement in efficiencies and reduced profile on the environment.

### SUMMARY OF THE INVENTION

The present invention relates to a process for treating an aqueous dispersion comprising water-insoluble polymer particles and water-soluble dispersant, the concentration of dispersant in water being less than that of the polymer particles, said process comprising subjecting the aqueous dispersion to solid particle filtration to obtain an aqueous solution comprising the water-soluble dispersant and being substantially free of the polymer particles, and then subjecting the aqueous solution to membrane filtration to obtain a permeate stream of substantially purified water and a retentate stream having an increased concentration of the dispersant.

In one embodiment, the membrane filtration uses a cross flow membrane filter for micro, nano, ultra or reverse osmosis permeabilities or semi-permeabilities and exhibits improved resistance to filter fouling by employing vibration, mechanical oscillation, ultrasonics, rotation, or other mechanical shear enhancing means at the interface between the membrane and aqueous filtrate.

In another embodiment, the membrane filtration uses a cross flow membrane filter having a porosity rating between 100 and 50,000 MWCO for micro, nano, ultra or reverse osmosis permeabilities or semi-permeabilities and exhibits improved resistance to filter fouling by employing vibration, mechanical oscillation, ultrasonics, rotation, or other mechanical shear enhancing means at the interface between the membrane and aqueous filtrate, and wherein the dispersant is a nonionic surfactant selected from the group consisting of alcohol ethoxylates, alkyphenol ethoxylates, ethylene oxide/propylene oxide block copolymers, fatty acid ethanol amides, and fatty acid sorbitol esters.

In one embodiment, the present invention describes a process for producing aqueous dispersions consisting of water, water soluble dispersant and water-insoluble polymer in solid particle form, and optionally other additives or substances that may be of benefit to the process or end-use product.

In another embodiment, the present invention describes a process for isolating a water-insoluble polymer in solid particle form by solids filtration from the aqueous solution of water, water-soluble dispersant and optionally other additives or substances that remain in the aqueous solution after solids filtration.

In another embodiment, the present invention washes the water-insoluble polymer particles with substantially pure water to remove residual dispersant from the particle surface as a secondary solids filtration step. The wash water is then added to the aqueous solution.

In another embodiment, the present invention optionally dries remaining moisture from the water-insoluble polymer particles and collects the evaporative water. The evaporative water from drying is then added to the aqueous solution. The water-insoluble polymer is collected after drying as a finely divided powder.

In another embodiment, the present invention introduces the dilute aqueous solution of water, water-soluble dispersants and optionally other additives or components that remain in the aqueous solution membrane filtration where the solution is divided into separate streams of 1) substantially pure water (permeate) and 2) an aqueous concentration of water, water-soluble dispersant and others additives or substances that remain after solids filtration (retentatc).

In another embodiment, the present invention reuses and/or recycles the separate streams of substantially pure water and aqueous concentration of water, water-soluble dispersant and others additives or substances that remain after solids filtration back into the process for production of aqueous dispersions.

### BRIEF DESCRIPTION OF THE DRAWING

The drawing shows a generalized schematic of a process of the invention.

### DETAILED DESCRIPTION OF THE INVENTION

The present invention addresses problems in the art of size reducing polymers using liquid-based dispersing systems, ideally aqueous dispersant solutions, recovering the particles as dry, finely divided particles, and recycling the aqueous dispersant in a process.

In processes for preparing dry, finely divided polymer particles from aqueous dispersions containing water-insoluble polymer particles and water-soluble dispersant, there is a need for technology to reuse the particle-free aqueous solution permeate from solids filtration. Those trained in the field recognize the need for processing technologies that can broaden the available field of polymers as dry, finely-divided powders. In the absence of an effective process for recycling water solutions from polymer particle recovery systems, the water must be disposed causing waste handling issues and higher costs for recovering dry, finely divided polymer particles. There are considerable waste handling and disposal issues especially in downstream use. A preferred approach would be to recycle the aqueous dispersant but there is a requirement for tight control of dispersing conditions and dispersant concentrations.

This invention can be used by any process for size reducing polymers in an aqueous medium using membrane filtration techniques. In one embodiment, shear enhanced cross flow membrane filtration systems are used to receive the solids filtration permeate aqueous solution, and control the retentate concentration for suitable reuse as the aqueous solution dispersant. Depending on the specific process, polymers being size reduced, or selection of dispersants, multiple configurations and designs of membrane filtration can be utilized for the purpose of providing a continuous closed loop process for recycling the aqueous dispersant from the production of dry, finely divided polymer powders.

Membrane filtration is a broadly defined term in which a mechanical and/or physical operation is used for the separation of solids from fluids (liquids or gases) by interposing a medium to fluid flow through which the fluid can pass, but the solids (or at least part of the solids) in the fluid are retained. The membrane separation process is based on the presence of a semi-permeable membrane that acts as a selective separation wall. The principle is quite simple in that the membrane acts as a very specific filter that will let water flow through, while it catches suspended solids and other substances. Suspended solids and solutes of high molecular weight are retained, while water and low molecular weight solutes pass through the membrane. There are various methods to enable substances to penetrate a membrane. Examples of these methods are the applications of high pressure, the maintenance of a concentration gradient on both sides of the membrane and the introduction of an electric potential. A semi-permeable membrane, also termed a selectively permeable membrane, a partially permeable membrane or a differentially permeable membrane, is a membrane which will allow certain molecules or ions to pass through it by diffusion and occasionally specialized “facilitated diffusion”. The rate of passage depends on the pressure, concentration and temperature of the molecules or solutes on either side, as well as the permeability of the membrane to each solute. Depending on the membrane and the solute, permeability may depend on solute size, solubility, properties, or chemistry.

Membrane filtration can be used as an alternative for flocculation, sediment purification techniques, adsorption (sand filters and active carbon filters, ion exchangers), extraction and distillation.

Membrane filtration has a number of benefits over other filtration systems. It works without the addition of chemicals. It is a process that can take place while temperatures are low. This is mainly important because it enables the treatment of heat-sensitive matter. It is a process with low energy cost. Most of the energy that is required is used to pump liquids through the membrane. The total amount of energy that is used is minor, compared to alternative techniques, such as evaporation. And finally, it is a process that can easily be expanded.

The choice for a certain kind of membrane system is determined by a great number of aspects, such as costs, risks of plugging of the membranes, packing density and cleaning opportunities. Membranes are never applied as one flat plate, because this large surface often results in high investing costs. That is why systems are built densely to enable a large membrane surface to be put in the smallest possible volume. Membranes are implemented in several types of modules. There are two main types, called the tubular membrane system and the plate and frame membrane system. Tubular membrane systems are divided up into tubular, capillary and hollow fiber membranes. Plate and frame membranes are divided up into spiral membranes and pillow-shaped membranes.

Membrane filtration systems can be managed in either dead-end flow or cross-flow. The purpose of the optimization of the membrane techniques is the achievement of the highest possible production for a long period of time, without fouling.

In the dead-end filtration technique all the fluid passes through the membrane, and all particles larger than the pore size of the membrane are retained at its surface. This means that the trapped particles start to build up a “filter cake” on the surface of the membrane, which has an impact on the efficiency of the filtration process. This mode of operation is used for high solids feeds and/or very low molecular weight substances because of the higher risk of fouling. With dead end filtration, solids material can quickly foul (block or blind) the filter surface.

In crossflow filtration, the feed is passed across the filter membrane (tangentially to the filter membrane) at some pressure difference. Material which is smaller than the membrane pore size passes through the membrane as permeate or filtrate, and everything else is retained on the feed side of the membrane as retentate. The speed of the feed flow parallel to the membrane is relatively high. The purpose of this flow is the control of the thickness of the solids cake. Consequentially to the flow speed of the feed, flowing forces are high, which enables the suspended solids to be carried away in the water flow. With crossflow filtration the tangential motion of the bulk of the fluid across the membrane causes trapped particles on the filter surface to be rubbed off. This means that a crossflow filter can operate continuously at relatively high solids loads without blinding.

During membrane filtration processes membrane fouling is inevitable, even with a sufficient pre-treatment. The types and amounts of fouling are dependent on many different factors, such as feed water quality, membrane type, membrane materials and process design and control. Particles, biofouling and scaling are the three main types of fouling on a membrane. These contaminants cause that a higher workload is required, to be able to guarantee a continuous capacity of the membranes. At a certain point the pressure will rise so much that it is no longer economically and technically accountable. Membrane filtration is very prone to fouling caused by increased solute concentration at the membrane surface (either by macromolecular adsorption to internal pore structure of membrane, or aggregation of deposit on surface of membrane), which leads to concentration polarization (CP). CP is the major culprit in decreasing permeates flux.

Industries such as chemical and pharmaceutical processing, food and beverage processing, and waste water treatment, employ membrane filtration to recycle water or to concentrate recovery of products. Membrane filtration's main attraction is its ability to purify, separate, and concentrate target macromolecules in continuous systems. Often, membrane filtration does this by pressurizing the solution flow, which is often tangential to the surface of the supported membrane (cross-flow filtration). The components that pass through the membrane are known as permeate. The components that do not pass through are known as retentate.

Depending on the Molecular Weight Cut-Off (MWCO) of the membrane used, macromolecules may be purified, separated, or concentrated in either fraction.

Membrane filtration systems are typically classified by their ability to filter different size molecules. Membrane filtration classifications include microfiltration, ultrafiltration, nanofiltration and reverse osmosis. These classifications are not fundamentally different from each other except in terms of the size of the molecules it retains as retentate. Microfiltration is generally defined as having a molecular weight greater than 200,000 Daltons (˜0.1 micron), ultrafiltration having a molecular weight greater than 10,000 Daltons (˜0.003 micron), nanofiltration having a molecular weight greater than 200 Daltons (˜0.001 micron) and reverse osmosis as having a molecular weight greater than 1 Dalton (˜0.0001 micron) in size.

In general, many advances have been made relative to filtration technologies, specifically membrane filtration, and more specifically Cross Flow Membrane filtration. It is most common to see such filtration systems being used to separate solids from liquid, such as contaminant particles, or recovering value-added inorganic, organic and biologically-active solids such as cells or proteins, such as that taught in U.S. Pat. No. 6,193,883 issued to Kroner et al.

Membrane filtration systems are used broadly in industrial and chemical process applications. Membrane filtration systems are primarily engineered for handling water-based liquid streams, often to remove particulates or macromolecules to purify the water. For those systems handling water with dispersants, such as surfactants, said systems are designed for assisting in the removal of insoluble particulates.

For example, membrane filtration is also used heavily in systems to remove water from oil and hydrocarbon streams, such as U.S. Pat. No. 6,764,598 assigned to Filtration Solutions, Inc. where surfactants are added to facilitate water agglomeration for efficient removal. By example, this demonstrates the rarity of a design need to separate the surfactant from the water. However, prior art has taught use of membrane filtration to separate surfactants from water where the surfactant is used to isolate molecules for product recovery or waste concentration, for example in U.S. Pat. No. 4,844,811 issued to Gotlieb for the recovery of organic solutes. U.S. Pat. Nos. 6,203,698 and 5,916,442 assigned to Goodrich teach the use of hydrophobic membrane filter media for rejecting water as a separate waste stream to concentrate recovery of organic or inorganic solutes. Similarly, U.S. Pat. No. 4,814,087 issued to Taylor teaches using a single stage cross flow membrane filter for water removal for concentrating products or waste. These prior art patents teach how to use membrane filtration for handling liquid streams containing water, but do not teach how to use them for purposely separating the purified water and reconstituting dispersants for the production of water insoluble polymeric particles using aqueous dispersion techniques.

U.S. Patent Application No. 2007/0083001 A1 issued to Amrhein et al teaches the use of membrane filtration to separate water insoluble polymer particles from aqueous particle dispersions. Amrhein et al demonstrates the usefulness of membrane filtration for concentrating water-insoluble solid particles for subsequent spray drying, such as by using a drying tower. However, Amrhein et al fails to teach the use of membrane filtration for reusing or recycling aqueous dispersant solution where substantially pure water is separated from concentrations of water soluble dispersants.

While membrane-based separations of liquids from solids have enjoyed increasing popularity over the last 20 years, the technology has an inherent Achilles heel that affects all membrane devices: fouling. This long-term loss in throughput capacity is due primarily to the formation of a boundary layer that builds up naturally on the membranes surface during the filtration process. In addition to cutting down on the flux performance of the membrane, this boundary or gel layer acts as a secondary membrane reducing the native design selectivity of the membrane in use. This inability to handle the buildup of solids has also limited the use of membranes to low-solids feed streams.

To help minimize this boundary layer buildup, membrane designers have used a method known as tangential-flow or cross-flow filtration that relies on high velocity fluid flow pumped across the membranes surface as a means of reducing the boundary layer effect. In this method, membrane elements are placed in a plate-and-frame, tubular, or spiral-wound cartridge assembly, through which the substance to be filtered (the feed stream), is pumped rapidly.

In cross-flow designs, it is not economic to create shear forces measuring more than 10-15 thousand inverse seconds, thus limiting the use of cross-flow to low-viscosity (watery) fluids. In addition, increased cross-flow velocities result in a significant pressure drop from the inlet (high pressure) to the outlet (lower pressure) end of the device, which leads to premature fouling of the membrane that creeps up the device until permeate rates drop to unacceptably low levels.

An alternative method for producing intense shear waves on the face of a membrane. The technique is called Vibratory Shear Enhanced Processing (VSEP™) and is manufactured by New Logic Research Company. In a VSEP™ System, the feed slurry remains nearly stationary, moving in a leisurely, meandering flow between parallel membrane leaf elements. Shear cleaning action is created by vigorously vibrating the leaf elements in a direction tangent to the faces of the membranes.

The shear waves produced by the membrane's vibration cause solids and foulants to be lifted off the membrane surface and remixed with the bulk material flowing through the membrane stack. This high shear processing exposes the membrane pores for maximum throughput that is typically between 3 and 10 times the throughput of conventional cross-flow systems.

The VSEP™ membrane filter pack consists of leaf elements arrayed as parallel discs and separated by gaskets. The disc stack resembles records on a record changer with membrane on each side.

The disk stack is oscillated above a torsion spring that moves the stack back and forth approximately ⅞ inches (2.22 centimeters). This motion is analogous to the agitator of a washing machine but occurs at a speed faster than that which can be perceived by the human eye.

The oscillation produces a shear at the membrane surface of about 150,000 inverse seconds (equivalent to over 200 G's of force), which is approximately ten times the shear rate of the best conventional cross-flow systems. More importantly, the shear in a VSEP™ System is focused at the membrane surface where it is cost effective and most useful in preventing fouling, while the bulk fluid between the membrane disks moves very little.

Because VSEP™ does not depend on feed flow induced shear forces, the feed slurry can become extremely viscous and still be successfully dewatered. The concentrate is essentially extruded between the vibrating disc elements and exits the machine once it reaches the desired concentration level. Thus, VSEP™ Systems can be run in a single pass through the system, eliminating the need for costly working tanks, ancillary equipment and associated valving.

At startup, the VSEP™ system is fed with a slurry and the concentrate valve is closed. Permeate is produced and suspended solids in the feed are collected inside the VSEP™ filter pack. After a programmed time interval, valve one is opened to release the accumulated concentrated solids. The valve is then closed to allow the concentration of additional feed material. This cycle repeats indefinitely.

Membrane selection is the single most important parameter that affects the quality of the separation. Other important parameters that affect system performance are pressure, temperature, vibration amplitude, and residence time. All of these elements are optimized during testing and entered into the programmable logic controller (PLC) which controls the system.

The operating pressure is created by the feed pump. VSEP™ machines can routinely operate at pressures as high as 1,000 psig (68.95 BAR). While higher pressures often produce increased permeate flow rates, they also use more energy. Therefore, an operating pressure is used that optimizes the balance between flow rates and energy consumption.

In most cases, the filtration rate can be further improved by increasing the operating temperature. The temperature limit on a standard VSEP™ system is 175° F. (79° C.), significantly higher than competitive membrane technology. Even higher temperature constructions are also available.

The vibration amplitude and corresponding shear rate can also be varied which directly affects filtration rates. Shearing is produced by the torsion oscillation of the filter stack Typically the stack oscillates with amplitude of ¾ to 1¼ inches (1.9 to 3.2 cm) peak to peak displacement at the rim of the stack. The oscillation frequency is approximately 53 Hz and produces a shear intensity of about 150,000 inverse seconds.

Feed residence time is set by the frequency of the opening and closing of the exit valve (valve one). The solids level in the feed increases as the feed material remains in the machine.

Other variations exist for improvements on Cross Flow Membrane filtration, such as that taught in U.S. Pat. No. 6,416,665 issued to McGrath. In this approach the filtration media is rotated as one of many options to reduce plugging, blinding and otherwise fouling of Cross Flow Membrane filtration systems. U.S. Pat. No. 6,808,634 issued to Zegg teaches another alternative Cross Flow Membrane filtration system to minimize filter fouling. According to Zegg, the membrane filters are moved relative to each other thereby preventing the need for backwashing the filters. Other methods for improving fouling could include maintaining acoustic or magnetic fields. Membrane filtration systems are further generally described in Paulson et al., “Crossflow Membrane Technology and Its Applications,” Food Technology, pages 77-111 (December 1984).

The membrane filtration method itself—which for the purposes of this specification is intended to mean microfiltration, ultrafiltration, nanofiltration, reverse osmosis in cross-flow, i.e. the separation of dissolved components of varying molecular weight or the separation of dissolved and un-dissolved components in a fluid medium-often water-on a suitable porous membrane, where the un-dissolved components and/or the dissolved components with higher molecular weight together with some of the fluid medium which are retained on the membrane (retentate) are separated from substantially pure water which passes through the porous membrane (permeate)—is known in principal to the person skilled in the art. The dissolved components here which are retained by the membrane(s) may be low-molecular-weight compounds with an average molecular weight greater than or equal to 200 Daltons.

For the membrane process it is in principle possible to use porous membranes whose pore diameters are from 1 nm (molecular separation limits about 1000 g/mol) to 0.5 micron (molecular separation limits about 1,000,000 g/mol). For the purification of water soluble compounds, the porous membranes which have proven particularly successful are those whose pore diameters are from 5 (molecular separation limits about 5 nm (10,000 g/mol) 200 nm (molecular separation limits about 500,000 g/mol).

The porous membranes may be composed of organic polymers, ceramics, metal, carbon, or a combination of these, and have to be stable in the aqueous dispersion medium at the filtration temperature. For mechanical reasons, the porous membranes have generally been applied to a porous single or multilayer structure.

It may be possible for water-insoluble particles small enough to permeate into the water-soluble compound stream. In order that the membrane pores do not become blocked by the water soluble compounds or residual water-insoluble particles, it is advisable for the porous membranes to have pore diameters of less than 50% of the average diameter of the particles to be filtered. However, depending on the nature of the surface of the membranes and on the constitution of polymer particles, other membranes which may be used with advantage are those with pore diameters approximately the same as the average particle diameter.

Particular preference is given to porous membranes which are composed of hydrophilic materials such as metal, ceramics, cellulosic, acryloniltrile, hydropholicized acrylonitrile, hydrophilicized polysulfone, or hydrophilicized polyether ether ketone.

The shape and or construction of the porous membrane used may be flat or tubular or that of a multi-channel element or capillary, and in appropriate pressure housings permitting separation of retentate and permeate.

The ideal transmembrane pressures between retentate side and permeate side depend in essence on the diameters of the membrane pores and respectively, on the molecular separation limits, on the hydrodynamic conditions effecting the build-up of the overlayer on the porous membrane, and on the mechanical stability of the porous membrane at the filtration temperature and pressure, typically between 0.2 to 50 bar depending upon the type of membrane. Higher transmembrane pressures generally lead to higher permeate flow rates. In a case where two or more retentate/membrane/permeate units, known as membrane modules, have been arranged in series, the permeate pressure may be raised so as to lower the transmembrane pressure for each module. The membrane filtration temperature depends upon the stability of the membrane, and also on the heat resistance of the aqueous polymer dispersion. Higher temperatures generally give higher permeate flow rates. The permeate flow rates achievable greatly depend upon the type of membrane chosen and the shape of membrane used, on the process conditions, and also on the water-soluble and water-insoluble content of the aqueous stream.

In order to increase the concentration of the compounds dissolved in the aqueous phase of the aqueous polymer dispersions, for example, surfactants, organic and inorganic salts, free radical initiators, emulsifiers, protective colloids, and oligomeric compounds, the aqueous polymer dispersion is brought into contact at superatmospheric pressure (>1 bar absolute) with a suitable porous membrane, and high water purity permeate drawn off the reverse side of the membrane at a pressure which is lower than that of the retentate side. The retentate obtained comprises an increased concentration of water-soluble and water-insoluble compounds. The increased concentration is advantageously concentrated from dilution containing excess water to an aqueous dissolved compound concentration equal to the preferred amount required for use back into the dispersion process. The aqueous dissolved compound is subjected to membrane filtration in such a way that the concentration is constant when processed on a continuous basis.

The membrane filtration process may be carried out batchwise via one or more passes of aqueous dispersion through one or more membrane modules arranged in parallel, or continuously via one or ore passes through one or more membrane modules arranged in series.

Dispersants used to facilitate size reducing polymers in aqueous dispersion processes can be nonionic, anionic, or cationic surfactants, emulsifying aids such as volatile organic solvents, acid containing polymers and salts of acids. The specific choice of dispersant depends on several variables such as polymer characteristics, targeted particle sizes and distributions, and solution viscosity. A preferred approach is to use only a surfactant with water, such as block polymers of EO and PO manufactured by BASF under the trade name “Pluronic”. Block copolymers with molecular weights above 2,000 g/mol, more preferably above 10,000 g/mol, are thermally stable with excellent shear stability for the micronization of many types of polymers.

Certain dispersants, such as surfactants, can also be used to form colloidal micelles around oligomeric molecules and macromolecules as a result of the particle dispersion conditions. Hydrocarbon oligomers and water-soluble oligomers containing hydrophilic functionality, i.e. from acid-olefin copolymers, will behave differently in micelle structures. Using the simple ‘like prefers like’ argument, micelle formation can be tailored effectively depending on the size and chemical nature of the molecule or macromolecule.

Polymers that may be size reduced by aqueous particle dispersion processes include but are not limited to natural and synthetic waxes, acrylonitrile butadiene styrene (ABS), celluloid, cellulose acetate, ethylene-vinyl acetate (EVA), ethylene vinyl alcohol (EVOH), fluoroplastics (PTFEs, including FEP, PFA, CTFE, ECTFE, ETFE), ionomers, liquid crystal polymer (LCP), polyacrylics (Acrylic), polyacrylonitrile (PAN or Acrylonitrile), polyamide (PA or Nylon), polybutadiene (PBD), polbutylene (PB), polybutylene terephthalate (PBT), polyethylene terephthalate (PET), polycarbonate (PC), polyhydrooxyalkonates (PHAs), polyethylene (PE), polyethylenechlorinates (PEC), polylactic acid (PLA), polymethylpentene (PMP), polyphenylene oxide (PPO), polyphenylene sulfide (PPS), polythalamide (PPA), polypropylene (PP), polystyrene (PS), polsulfone, (PSU), polyvinyl chloride (PVC), polyvinylidene chloride (PVDC), polymethylmethacrylate (PMMA), and copolymers, grafts, blends, compounds or alloys of polymers made therefrom. Polymers may also be filled and/or reinforced or contain functional additives such as pigments, fragrances, foaming agents, or other chemical additives. Appropriately, the most preferred polymers are those with average molecular weight between 1,000 Daltons to more than 1,000,000 Daltons.

There is also an industrial need for size reducing thermosetting or crosslinking polymers. The preferred method of size reducing polymers of this invention is equally adaptive to thermosetting resins such as epoxies, polyesters, epoxy-polyester hybrids, and urethanes.

The membrane filtration technology of this invention can be engineered to remove soluble or insoluble contaminants such as dies, resin binders, or other additives associated with thermosetting polymers.

Depending on the specific polymer being sized reduced, Shear Enhanced Cross Flow Membrane filtration systems can be utilized in various configurations depending on the specific separation and reconstitution requirements. For example, some acid-ethylene copolymers have functionalized oligomeric material that is readily soluble in water; especially during the high temperature process of the dispersing zone of the process. Additional membrane filtration systems can be used to remove such potentially contaminating molecules, or, to remove insoluble contaminant materials.

The present invention provides an improved process for preparing an aqueous particle dispersion containing water-insoluble polymer particles and aqueous solution of water-soluble dispersant, the fraction of such dispersant being smaller than that of said polymer particles, which comprises subjecting the aqueous particle dispersion to solid particle filtration and secondarily subjecting the practically particle-free aqueous solution to membrane filtration where the permeate stream is substantially purified water and the retentate stream has an aqueous solution concentration, both of which are suitable for reuse or recycle back into aqueous particle dispersion production.

The most preferred membrane filtration method is cross flow membrane filtration and even more preferred, shear enhanced processing which is an improvement on Cross Flow Membrane filtration designs to reduce filter media fouling. The most preferred cross flow filtration method is Vibratory Shear Enhanced Processing (VSEP™) membrane filtration manufactured by New Logic Research Company.

The drawing is a generalized schematic depicting one embodiment of this invention. Unit Operation 1 represents any generally known solids filter and method for separating or filtering polymer particle solids from solid/liquid dispersions, represented as Flow 1c. Flow 1a is the recovered wet cake of solid particles sent to Dryer Unit Operation 2. Exiting the Dryer, flow 2a, is the final dried polymer particle as a bulk powder. The Condensate Flow 2b can be recycled to Water Return Tank Unit Operation 4 for reuse as substantially pure water to be re-used as wash water.

Flow 1b from Solids Filter Unit Operation 1 is an aqueous solution of water, water soluble dispersant and optionally other additives or components that remain in the aqueous solution. Membrane Filter Unit Operation 3 can be any suitable membrane filter, but typically is a preferred Cross Flow Membrane filtration system designed for ultra, micro, nano or reverse osmosis filtration. More preferably, Unit Operation 3 is a Shear Enhanced Cross Flow Membrane filter due to known benefits of resistance to filter fouling and superior long-term flux.

In Unit Operation 3, substantially pure water is separated from the aqueous solution as represented by Permeate Flow 3d. If desirable, Permeate Flow 3d may be further processed through any type of second membrane filter, such as but not limited to ultra, nano, micro, or reverse osmosis membranes to further remove even lower molecular weight species. The intention is to create a substantially pure water stream of Permeate in Flow 3d for re-use as wash water in Permeate Flow 4a during solid/liquid filtration.

Any aqueous dispersion solution used for size reduction of polymeric materials, especially copolymers or those with additives, may develop variable concentrations of low molecular weight residuals. These organic or inorganic residuals that are not separated by solids filtration are introduced to membrane filtration. Depending on the size and nature of the soluble and/or insoluble molecules or macromolecules, dispersants can be used to effectively form micelles for either waste concentration, or reused in the process. Low molecular weight species will be separated as micelles in the concentrated dispersant solution in Retentate Flow 3a where they may be reused and/or recycled back into the process in Flow 3b or may be introduced to a second membrane filter for removal of unwanted residuals or contaminants and diverted to waste in Flow 3c to Waste Tank Unit Operation 5 using any appropriate diverter valve.

In one aspect of operating the system described in the drawing, controlling Membrane Filter Unit Operation 3 allows one to control dispersant concentrations in Retentate Flow 3a suitable for recycling in Flow 3b to the dispersion zone of any suitable process for making aqueous particle dispersions.

### EXAMPLES

The following examples are for illustrative purposes only and are not intended to limit the scope of this invention. The examples illustrate membrane filtration of an aqueous solution of water soluble dispersant and water after water insoluble particles are removed in Solids Filter Unit Operation 1.

For the examples, a vibratory shear enhanced cross flow membrane filtration system manufactured by New Logic Research Company under the Trademark VSEP™ is used. The VSEP™ filtration system consists of 5 major components: the frame, drive system, plumbing, filter pack and control system. The process of this invention can be operated continuously, semi-continuously or batch-wise.

Variables for testing include membrane selection, water flux, temperature, pressure, concentration factor and fouling.

For the examples, several different filtration membranes are preliminarily tested.

| | Pore Size | Max. | | |
|---|---|---|---|---|
| | Rating | Temp. | Water Flux | |
| Membrane | (Daltons) | (° C.) | (gal/ft²/day) | Membrane Composition |
| A | 10,000 | 50 | 119 | Polyacrylanitrile |
| B | 10,000 | 55 | 68 | Regenerated Cellulose |
| C | 10,000 | 90 | 216 | Polyethersulfone |
| D | 7,000 | 90 | 205 | Polyethersulfone |
| E | 500 | 90 | 95 | Thin-film |
| | | | | Non-Polyamide |

A batch membrane cell is utilized to quantitatively measure ability to provide acceptable flux and substantially pure water permeate quality.

| | Starting Flow | Ending Flow | Pumping Feed | Solids |
|---|---|---|---|---|
| Membrane | (ml/min) | (ml/min) | Pressure (psi) | (%) |
| A | 147.4 | 135.2 | 100 | 0.13 |
| B | 108.7 | 107.1 | 100 | 0.00 |
| C | 74.5 | 53.7 | 100 | 0.03 |
| D | 84.3 | 54.3 | 100 | 0.00 |
| E | 81.2 | 80.6 | 100 | 0.00 |

Membrane “E” is selected for use in the examples because it provides acceptable flux as measured by starting and ending flow and high purity water permeate. Membrane “E” is thus a more efficient filter having a much smaller pore size.

### Example 1

This example demonstrates the improved process of the invention whereby membrane filtration is utilized to separate substantially pure water (permeate) from an aqueous concentrated solution of water, water soluble dispersant and optionally other additives or substances that remain in the aqueous solution after solids filtration. About 0.5% by weight of a water soluble nonionic surfactant dispersant (Pluronic F-98, a difunctional block copolymer of ethylene oxide and propylene oxide with average molecular weight of 13,500 Daltons and containing 20% propylene oxide) and 99.5% by weight of substantially pure water are mixed until completely solubilized. The aqueous feed is then pumped into the membrane filtration system. Membrane filtration is conducted using Thin Film Non-Polyamide Membrane “E” with a system membrane filter area of 0.5 square feet, an aqueous feed temperature of 30° C. (ambient), and pumping feed pressure of 400 pounds per square inch.

| | | Retentate | Retentate | |
|---|---|---|---|---|
| | | Starting | Ending | Permeate |
| | | Solids | Solids | Ending |
| Starting Flux | Ending Flux | (% | (% | Solids (% |
| (gal/ft²/day) | (gal/ft²/day) | dispersant) | dispersant) | dispersant) |
| 172.3 | 10.9 | 0.5 | 9.19 | 0.00 |

The results show the membrane system's ability to provide high concentration levels of dispersant in the retentate stream and substantially pure water in the permeate stream both for reuse and/or recycle back into the particle dispersion manufacturing process. The flux rate shows the volumetric flow rate of permeate after long-term (steady state) stabilization of the process.

### Example 2

Example 1 is repeated except that varying amounts of contaminant are added to the aqueous solution feed stream to provide evidence that the membrane filter is resistant to fouling when water insoluble polymer particles are intentionally or unintentionally present in the aqueous solution feed stream. The contaminant in this case is a water-insoluble solid of spherically shaped low density polyethylene (LDPE) particles with a melt index of 10 grams/minute, density of 0.923 grams/cc and number average particle size of 17 microns and particle size distribution between about 0.5 and 50 microns.

The following table shows membrane filter performance after contaminated with said water insoluble LDPE particles.

| LDPE Particle | Starting Flux | Ending Flux | Permeate Ending |
|---|---|---|---|
| (ppm) | (gal/ft²/day) | (gal/ft²/day) | Solids (%) |
| 0 | 146.0 | 150.8 | 0.00 |
| 58 | 150.0 | 149.9 | 0.00 |
| 116 | 150.7 | 146.1 | 0.00 |
| 175 | 146.8 | 146.8 | 0.00 |
| 309 | 146.1 | 141.1 | 0.00 |
| 448 | 141.1 | 135.0 | 0.00 |

The results show that the contaminant does not significantly affect membrane performance or qualities of the substantially pure water permeate. The invention thus provides a process for treating an aqueous dispersion comprising water-insoluble polymer particles and water-soluble dispersant, the concentration of dispersant in water being less than that of the polymer particles, said process comprising subjecting the aqueous dispersion to solid particle filtration to obtain an aqueous solution comprising the water-soluble dispersant and being substantially free of the polymer particles, and then subjecting the aqueous solution to membrane filtration to obtain a permeate stream of substantially purified water and a retentate stream having an increased concentration of the dispersant.

What is claimed is:

1. A process for treating an aqueous dispersion comprising water-insoluble polymer particles and water-soluble dispersant, the concentration of dispersant in water being less than that of the polymer particles, said process comprising subjecting the aqueous dispersion to solid particle filtration to obtain an aqueous solution comprising the water-soluble dispersant and being substantially free of the polymer particles, and then subjecting the aqueous solution to membrane filtration to obtain a permeate stream of substantially purified water and a retentate stream having an increased concentration of the dispersant.

2. A process according to claim 1, wherein the permeate stream is reused and/or recycled as wash water during the solid particle filtration.

3. A process according to claim 1, wherein the retentate stream is recycled as aqueous dispersant for size reducing the water-insoluble polymer particles at a temperature at or above the softening point of the polymer.

4. A process according to claim 1, wherein said water-insoluble polymer particles are made from thermoplastic material selected from the group consisting of natural and synthetic waxes, acrylonitrile butadiene styrene, celluloid, cellulose acetate, ethylene-vinyl acetate, ethylene vinyl alcohol, fluoroplastics, ionomers, liquid crystal polymer, polyacrylics, polyacrylonitrile, polyamide, polybutadiene, polybutylene, polybutylene terephthalate, polyethylene terephthalate, polycarbonate, polyhydrooxyalkonates, polyethylene, polyethylenechlorinates, polylactic acid, polymethylpentene, polyphenylene oxide, polyphenylene sulfide, polythalamide, polypropylene, polystyrene, polsulfone, polyvinyl chloride, polyvinylidene chloride and polymethylmethacrylate, and copolymers, grafts, blends, compounds or alloys of polymers made therefrom.

5. A process according to claim 1, wherein said water-insoluble polymer particles are made from thermosetting material selected from the group consisting of epoxies, polyesters, epoxy-polyester hybrids, urethanes, phenolics, polyureas, acrylates, and acrylics, and copolymers, grafts, blends, compounds or alloys of polymers made therefrom.

6. A process according to claim 1, wherein the membrane filtration uses a cross flow membrane filter for micro, nano, ultra or reverse osmosis permeabilities or semi-permeabilities.

7. A process according to claim 6, wherein the cross flow membrane filter exhibits improved resistance to filter fouling by employing high shear forces at the interface between the membrane and aqueous filtrate.

8. A process according to claim 6 where the cross flow membrane filter is performance enhanced by vibration, mechanical oscillation, ultrasonics, rotation, or other mechanical shear enhancing means.

9. A process according to claim 6 where the cross flow membrane filter is performance enhanced by temperature, pressure, vacuum or magnetics.

10. A process according to claim 6, wherein the membrane filtration is applied in series configuration.

11. A process according to claim 6, wherein the membrane filtration separates organic or inorganic additives or extractions from said polymers.

12. A process according to claim 6, wherein the membrane filter has a porosity rating between 100 and 50,000 MWCO.

13. A process according to claim 1, wherein the dispersant is present in the aqueous solution at a concentration ranging from about 0.1 to about 30 percent by weight.

14. A process according to claim 1, wherein the permeate stream of substantially purified water comprises less than or equal to 1 percent by weight of water-soluble dispersant and soluble or insoluble organic material.

15. A process according to claim 13, wherein the dispersant is a nonionic, anionic, or cationic surfactant.

16. A process according to claim 13 wherein the dispersant is a nonionic surfactant selected from the group consisting of alcohol ethoxylates, alkyphenol ethoxylates, ethylene oxide/propylene oxide block copolymers, fatty acid ethanol amides, and fatty acid sorbitol esters.

17. A process according to claim 13 wherein the dispersant is an anionic surfactant selected from the group consisting of alkylbenzene sulfonates, lignsulfonates, petroleum sulfonates, alkyl sulfates, alkylaryl polyether sulfonates and alkylaryl polyether sulfates.

18. A process according to claim 1, wherein the aqueous dispersion further comprises an organic monomer or oligomer that is filtered out by the membrane filter.

19. A process for treating an aqueous dispersion comprising water-insoluble polymer particles and water-soluble dispersant, the concentration of dispersant in water being less than that of the polymer particles, said process comprising subjecting the aqueous dispersion to solid particle filtration to obtain an aqueous solution comprising the water-soluble dispersant and being substantially free of the polymer particles, and then subjecting the aqueous solution to membrane filtration to obtain a permeate stream of substantially purified water and a retentate stream having an increased concentration of the dispersant, wherein the membrane filtration uses a cross flow membrane filter for micro, nano, ultra or reverse osmosis permeabilities or semi-permeabilities and exhibits improved resistance to filter fouling by employing vibration, mechanical oscillation, ultrasonics, rotation, or other mechanical shear enhancing means at the interface between the membrane and aqueous filtrate.

20. A process for treating an aqueous dispersion comprising water-insoluble polymer particles and water-soluble dispersant, the concentration of dispersant in water being less than that of the polymer particles, said process comprising subjecting the aqueous dispersion to solid particle filtration to obtain an aqueous solution comprising the water-soluble dispersant and being substantially free of the polymer particles, and then subjecting the aqueous solution to membrane filtration to obtain a permeate stream of substantially purified water and a retentate stream having an increased concentration of the dispersant, wherein the membrane filtration uses a cross flow membrane filter having a porosity rating between 100 and 50,000 MWCO for micro, nano, ultra or reverse osmosis permeabilities or semi-permeabilities and exhibits improved resistance to filter fouling by employing vibration, mechanical oscillation, ultrasonics, rotation, or other mechanical shear enhancing means at the interface between the membrane and aqueous filtrate, and wherein the dispersant is a nonionic surfactant selected from the group consisting of alcohol ethoxylates, alkyphenol ethoxylates, ethylene oxide/propylene oxide block copolymers, fatty acid ethanol amides, and fatty acid sorbitol esters.
